(19) United States
(12) Patent Application Publication
(10) Pub. No.: US 2015/0241254 A1
(43) Pub. Date: Aug. 27, 2015

(54) Fluid Flow Indicator and Method

(71) Applicants: Michael A DeVita, (US); Andrew P Hutelmeyer, (US)

(72) Inventors: Michael A. DeVita, Rowayton, CT (US); Andrew P. Hutelmeyer, Gibsonia, PA (US)

(73) Assignee: Dynamic Medical Strategies, LLC, Gibsonia, PA (US)

(21) Appl. No.: 14/637,029

(22) Filed: Mar. 3, 2015

Related U.S. Application Data
(63) Continuation of application No. 13/205,602, filed on Aug. 8, 2011, now abandoned.

(51) Int. Cl. G01F 1/10

(52) U.S. Cl. CPC G01F 1/10

(57) ABSTRACT

A fluid flow monitor is disclosed which indicates positive flow of fluids through conduit, tubing and the like. It is particularly adapted to indicate flow of colorless fluids within a transparent viewing chamber. The visual indication of positive fluid flow is the rotation of an impeller within the viewing chamber. The impeller, in combination with the device as a whole is designed to minimize restriction on fluid flow, including at any time that impeller motion is retarded or otherwise prevented.

### CROSS REFERENCE TO RELATED APPLICATIONS

This application is a continuation application and claims the benefit under 35 U.S.C. §120 of U.S. application Ser. No. 13/205,602, filed on Aug. 8, 2011 entitled Fluid Flow Indicator and Method, which is a utility application that claims the benefit of U.S. Provisional Application No. 61/459,059 filed on Dec. 6, 2010.

### BACKGROUND OF THE INVENTION

1. Field of the Invention

The present invention relates to fluid flow monitors. More specifically, the invention relates to an indication device which provides visual confirmation that fluid is flowing within a conduit.

2. Description of the Prior Art

Fluids are typically transported within conduit, which may further comprise tubing or other piping, both flexible and inflexible. Many fluids are colorless and, once any residual gas is evacuated from the conduit, provide no visual indication that the fluid is flowing or stationary therein. There are many situations in which one would want to verify that a fluid, either liquid or gas, is flowing within the conduit. One particular situation in which the need to confirm gas flow is particularly important is the flow of gas, such as oxygen, to a human recipient for breathing. This is particularly true for those persons who have a compromised medical condition, which is controlled and stabilized by the administration of at least one gas. Individuals who receive oxygen supplements often decompensate during transportation from locations within a medical facility. Such decompensation appears to result from a variety of causes, including an obstruction in the individual's oxygen supply tubing or from the depletion of oxygen within their storage cylinders. Although products exist to regulate and monitor gas flow at the origin of the gas (e.g. the gas cylinder), there is no device available, suitable for a health care setting, that provides a positive visual confirmation that oxygen, or any other colorless fluid, is flowing through a patient's supply tube. The only current method of determining if a patient is experiencing decompensation and eventually hypoxia is by noticing that the patient is blue in the face.

Several inventions have attempted to address the problem of verifying gas flow. See e.g., Monnig, U.S. Pat. No. 5,273,084; Gannon, et al., U.S. Pat. No. 6,431,158; Bromster, U.S. Pat. No. 6,128,963; Wallen, et al., United States Patent No. 6.058,786; Fry, et al., U.S. Pat. No. 4,401,116; McDermott, U.S. Pat. No. 6,326,896; Pilipski, U.S. Pat. No. 4,175,617; Schiffmacher, U.S. Pat. No. 5,040,477 and Hoffman, U.S. Pat. No. 5,057,822.

The Roto-Flo device, by Sigma-Aldrich, indicates the flow of a gas through tubing by utilizing a paddle-wheel device used to monitor gas flow in laboratory environments. The Roto-Flo, like many of the other inventions of the prior art, has multiple medical clinical disadvantages compared to the present invention. Its primary shortcoming, like many of the devices of the prior art, is that if the device binds or otherwise fails during use, the paddle-wheel design may impede the flow of oxygen to the patient. Many of the prior art devices, including the Roto-Flo, also do not provide for visibility entirely around the visible exterior of the tubing, in which observers can detect the presence or absence of indicator motion.

Furthermore, many of the devices of the prior art are not safe in a medical environment, particularly when oxygen is directly being flowed to a patient. Such direct oxygen flow is common in hospitals, nursing homes and in home health situations. The present invention can be used in multiple fields of study and health care that employ gas flow through tubing.

Accordingly, what is lacking in the art is a clearly visible, in-line indicator for tubing or other conduit which depicts fluid flow. Such a device should also be configured such that any failure of movement or other binding permit the continued, unimpeded flow of the fluid.

### SUMMARY OF THE INVENTION

The present invention is a device comprising a cylindrical tube, an inline impeller and gas inlet/outlet. When fluid, preferably gas, flows through the cylindrical tube, the impeller spins. In one preferred embodiment, to facilitate the visual observation that the impeller is spinning or has ceased spinning, the impeller is painted in two colors, even more preferably visually contrasting colors, such as blue and red. In the event that the impeller fails to turn, the design permits the fluid to continue to flow unimpeded through the conduit. In a preferred oxygen gas flow embodiment, the device is preferably inserted in the tubing proximal to a patient's nasal attachment/facemask.

The device can be incorporated in-line with existing tubing or other conduits of any fluid flow design. More specifically, the device of the present invention can be built into tubing, or can be a stand-alone device that can be added into a fluid flow circuit. The device is therefore connected to a source of fluid and a target for that fluid, receiving and consequently exhausting the fluid after passage across the impeller. The present invention is preferably compatible with standard gas tubing currently available. The helical impeller of the present invention is helical such that it can conduct fluid even if the impeller is not moving. The helical component is low resistance and conducts fluid effectively without creating a significant pressure or flow gradient across the device. When the fluid flow within the device of the present invention exceeds a certain threshold rate, the impeller spins. The device provides visual evidence that fluid flow within a fluid circuit is present, and above a certain threshold rate. The present invention spins at a predetermined threshold rate, and continues spinning at any flow rate above the established threshold rate.

The flow monitor will be best understood by reading the following detailed description of the preferred embodiments and with reference to the attached drawings described below.

### BRIEF DESCRIPTION OF DRAWINGS

FIG. 1 is an isometric view of a first embodiment of the flow monitor contained in a discrete housing.

FIG. 2 is a sectional view of the flow monitor illustrated in FIG. 1.

FIG. 3A is an isometric view of a housing of a second embodiment of the flow monitor.

FIG. 3B is an isometric view of an impeller of the second embodiment of the flow monitor.

FIG. 3C is an isometric view of a shaft of the second embodiment of the flow monitor.

FIG. 4 is a sectional view of the second embodiment of the flow monitor.

FIG. 4A is a detailed view that is a close of up of circle 4A of FIG. 4.

### DETAILED DESCRIPTION OF THE PREFERRED EMBODIMENTS

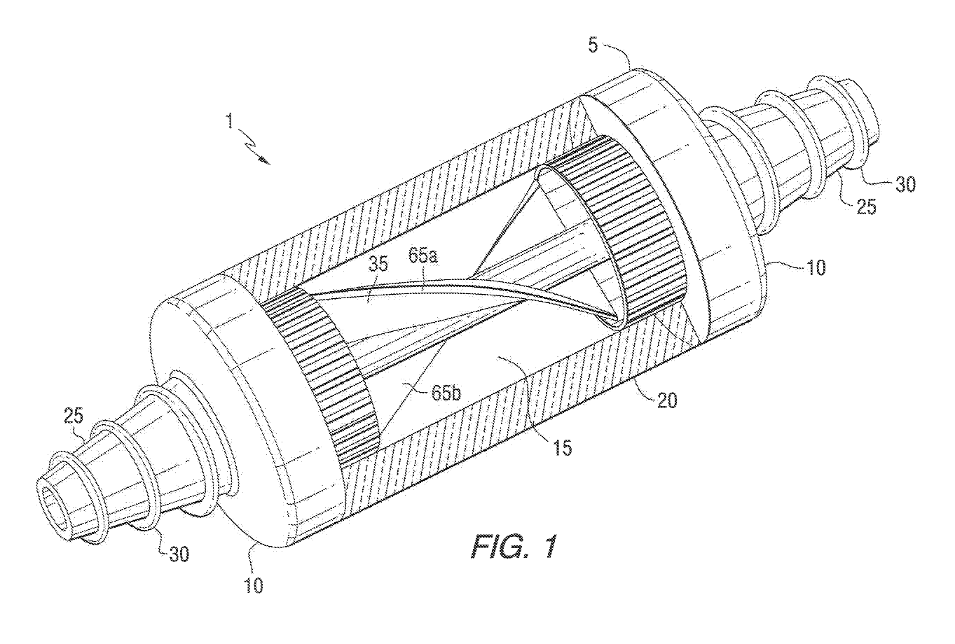

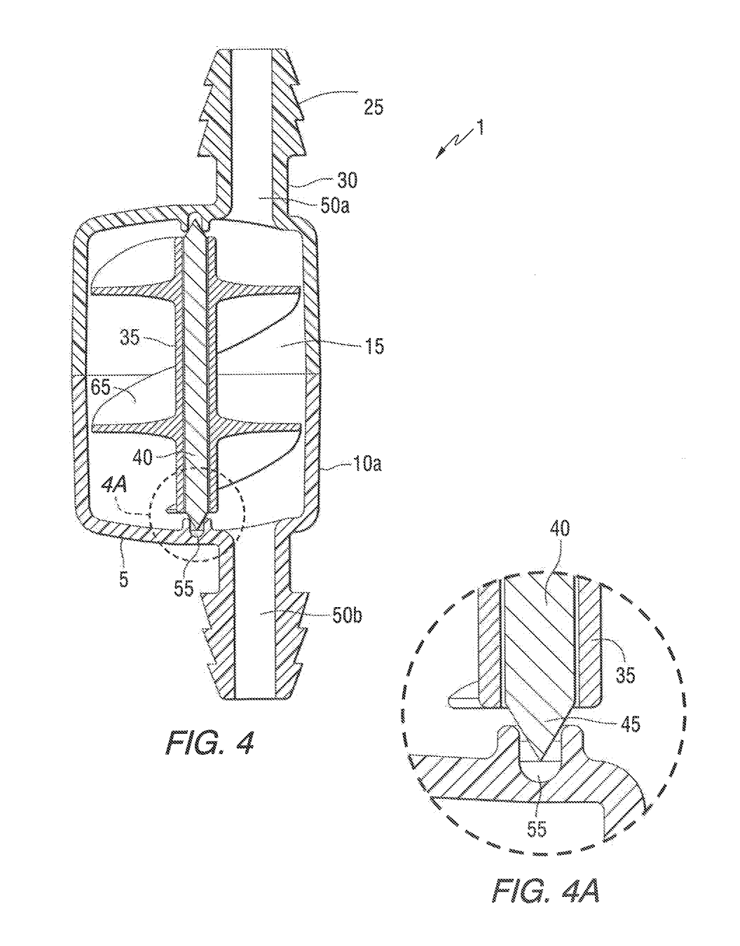

Referring now to FIGS. 1 and 4, a flow monitor 1 is depicted having a housing 5 further comprised of endcaps 10, 10a which enclose central chamber 15 formed by cylindrical casing 20. Endcaps 10 are preferably constructed of plastic or other durable resinous material. Endcaps 10a are preferably formed of a clear material. Cylindrical casing 20 is preferably transparent to permit clear viewing of the operative components of flow monitor 1 and may be constructed of acrylic or other clear plastic material. Cylindrical casing 20a may further be provided in a bowed embodiment to enhance viewing of impeller 35 therein. Endcaps 10 are terminated by nipples 25 which are adapted to connect to or otherwise receive and restrain flexible fluid tubing or conduit of known type. Nipples 25 are optionally provided with ribs 30 to facilitate the retention of tubing thereon. Nipples 25 are preferably frusto-conical in section in order to facilitate the insertion of nipple 25 in such tubing or conduit. Rotatably mounted within central chamber 15 and supported by endcaps 10 is impeller 35. One overall design consideration for the flow monitor 1 is small size and lightweight construction to reduce interference with the use or application of the tubing or conduit in which the device is mounted. Other design criteria include the selection of materials which are inert to the fluids being transported, especially an oxygen rich environment. Additionally, the device operates within a temperature range at which animals may exist, which includes the range of 20-110° F.

Referring now to FIGS. 1, 2, 3A, 3B, 3C, 4 and 4A, impeller 35 is preferably constructed of plastic or other molded resinous material is mounted on a rotatable shaft 40 having shaft bearing ends 45. Rotatable shaft 40 is preferably constructed of metal or any other durable material which resists warping, bending or other displacement. Alternatively, impeller 35 and rotatable shaft 40 may be constructed integrally of any suitable material which permits rotation and resists bending or other displacement. Endcaps 10, 10a are hollow, the central portion of which forms a fluid chamber 50 which is in fluid communication with central chamber 15. The combination of fluid chambers 50a, b and central chamber 15 comprise an unimpeded fluid flow path entirely through flow monitor 1.

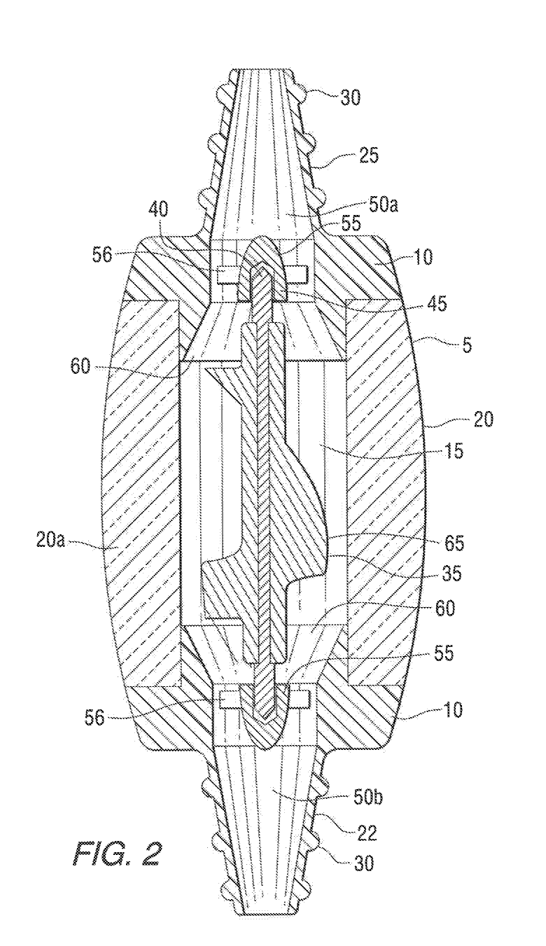

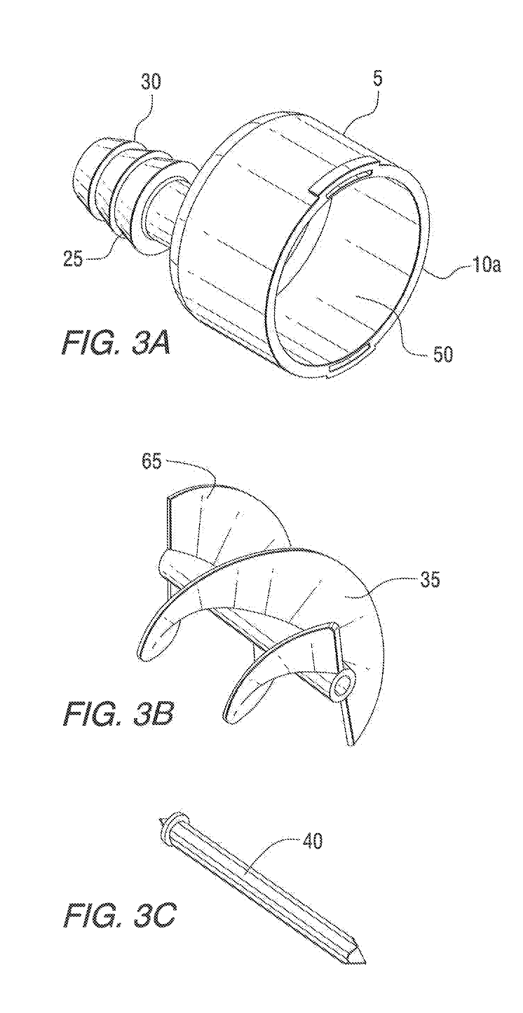

Each endcap 15 supports, within fluid chambers 50, an endcap bearing 55 which is adapted to receive and restrain shaft bearing ends 45 of rotatable shaft 40 in a rotatable engagement. Endcap bearings 55 are supported within fluid chambers 50 by support arms 56 in FIGS. 1, 2. Endcap bearings 55 are molded into endcaps 10a in the second embodiment of FIGS. 3A, 3B, 3C, 4 and 4A. Support arms 56 are sized and oriented to minimize any impediment to fluid flow through fluid chambers 50. Rotatable shaft 40 is adapted to be freely rotatable within endcap bearings 55. Bushings may be incorporated within endcap bearings 55, shaft bearing ends 45 or be independent, removable components (not shown) to reduce friction and improve impeller rotation. Design of the specific bearing surfaces and bushings is well within the ambit of one skilled in the art and may further include resinous materials such as Delrin® by DuPont to enhance rotation. Additionally, jewel bearings may be implemented to further improve rotational performance (not shown). Impeller 35 is adapted to rotate, irrespective of the orientation of flow monitor 1, from 0.5 to 30 L/min and preferably from 3-30 L/min.

Referring now to FIGS. 1-2, endcaps 25 are further provided with fluid ports 60 which are generally frusto-conical and are adapted to direct fluid flow from fluid chambers 50 through central chamber 15 in order to maximize impingement of such fluid on impeller 35. It is to be specifically noted that fluid monitor 1 is omnidirectional and may be mounted such that the fluid flows in either direction.

Referring now to FIGS. 1, 2, 3A, 3B, 3C, 4 and 4A, impeller 35 is provided with at least one, and preferably two helical vanes 65a, b which are oriented about the rotatable shaft 40. Helical vanes 65 are of a conventional design and extend 180° each around rotatable shaft 40. Helical vanes 65 may additionally be provided with coloring of various designs to improve visibility of both impeller 35 and its rotational motion. It is to be specifically noted that helical vanes 65 may be provided in a variety of sizes, orientations, periods and multiples, dependent upon the particular application of fluid monitor 1.

In operation, having a helical design, impeller 35 spins, providing a visual indication of rotation, when the pressure exerted by fluid passing through fluid chambers 50 and central chamber 15 on helical vanes 65 is sufficient enough to overcome the coefficient of friction between the shaft bearing ends 45 and endcap bearings 55. If impeller 35 ceases to spin for any reason, the design of impeller 35, fluid chambers 50 and support arms 56 permit the free flow of fluid therethrough to the desired target location. The helical design of impeller 35 enables it to conduct fluid even if impeller 35 is not moving. Further, the design of fluid monitor 1 does not reduce the rate of fluid flow when in motion. When in motion, the impeller is visible to persons of normal vision and distances that would be experienced in each application but which would include ranges that exceed six feet.

The above detailed description teaches certain preferred embodiments of the present device. While preferred embodiments have been described and disclosed, it will be recognized by those skilled in the art that modifications and/or substitutions are within the true scope and spirit of the present invention, as defined by the appended claims.

What is claimed is:

1. A fluid flow monitor, comprising:
a housing having a fluid chamber;
a plurality of fluid conduit connectors for engaging a source of fluid and a destination for said fluid and facilitating flow of said fluid through said housing; and
a rotatable impeller mounted within said fluid chamber activated by said flow of said fluid through said fluid chamber, wherein said rotatable impeller permits substantially unimpeded fluid flow through said fluid chamber when said rotatable impeller's rotation is impeded.

2. A fluid flow monitor of the type described in claim 1, wherein said impeller further comprises at least one helical vane.

3. A fluid flow monitor of the type described in claim 2, wherein said helical vane is multicolored to enhance detection of motion of said vane.

4. A fluid flow monitor of the type described in claim 2, further comprising a plurality of helical vanes having different colors to enhance detection of motion of said vane.

5. A fluid flow monitor of the type described in claim 2, wherein said at least one helical vane extends 180 degrees around said impeller.

6. A fluid flow monitor of the type described in claim 1, wherein said impeller further comprises a central shaft and at least one helical vane.

7. A fluid flow monitor of the type described in claim 6 wherein said impeller and said central shaft are formed integrally with each other.

8. A fluid flow monitor of the type described in claim 1 wherein said housing further comprises a transparent section permitting observation of said impeller within said fluid chamber.

9. A fluid flow monitor of the type described in claim 1 wherein said fluid conduit connectors are adapted to receive and restrain flexible tubing.

10. A fluid flow monitor of the type described in claim 9 wherein said fluid conduit connectors are frustoconical in shape and further comprise at least one rib for receiving and restraining said flexible tubing.

11. A fluid flow monitor of the type described in claim 1 wherein said housing is formed integrally with a conduit connecting said source and said destination of said fluid.

12. A fluid flow monitor of the type described in claim 1 further comprising a bearing surface mounted on said housing which receives and facilitates the rotation of said impeller.

13. A fluid flow monitor of the type described in claim 12 wherein said bearing surface is mounted integrally within said housing.

14. A fluid flow monitor of the type described in claim 12 wherein said bearing surface is suspended within said fluid chamber.

15. A fluid flow monitor of the type described in claim 6 wherein said central shaft further comprises a bearing engagement surface for engaging a bearing surface affixed to said housing.

16. A fluid flow monitor of the type described in claim 1 wherein said housing comprises a plurality of endcaps and a cylindrical casing centrally mounted between said endcaps.

17. A fluid flow monitor of the type described in claim 1 wherein said housing comprises a pair of endcaps mounted to each other.

18. A fluid flow monitor of the type described in claim 17 wherein said endcaps are transparent.

19. A fluid flow monitor of the type described in claim 1 wherein said impeller is adapted to rotate at fluid flow rates between 0.5 and 30 L/min.

20. A fluid flow monitor of the type described in claim 19 wherein said impeller is adapted to rotate at fluid flow rates between 3 and 30 L/min.
